(19) United States
(12) Patent Application Publication
(10) Pub. No.: US 2020/0402023 A1
(43) Pub. Date: Dec. 24, 2020

(54) METHOD AND SYSTEM FOR RECYCLING REIMBURSEMENT

(71) Applicant: SUGI GROUP AB, Stockholm (SE)

(72) Inventor: Suwar MERT, Hässelby (SE)

(21) Appl. No.: 16/965,715

(22) PCT Filed: Jan. 29, 2019
(86) PCT No.: PCT/SE2019/050066

§ 371 Date: Jul. 29, 2020

(30) Foreign Application Priority Data
Jan. 30, 2018 (SE) 1850104-9

(51) Int. Cl. G06Q 10/00; G07F 7/06; G06K 7/14; H04W 4/024

(52) U.S. Cl. CPC G06Q 10/30; H04W 4/024; G06K 7/1439; G07F 7/06

(57) ABSTRACT

A method for registering a reimbursement to a user depositing a plurality of recyclable articles for recycling, includes: a) providing a respective visually readable marking on each article visually representing a respective code; b) in a first location, using the camera of a mobile computer device to visually depict the marking of each article, and automatically interpreting the respective code; c) in a second location, the mobile device reading a location signal; d) comparing the read signal to a corresponding predetermined physical location or area; e) in the second location, the mobile device visually depicting the respective marking of each of a verification subset of the articles; f) verifying that the codes each corresponds to a respective article in the plurality and/or that all of the articles in the verification subset have been interpreted; and in case the verifications performed in step f) is positive, automatically registering the reimbursement.

### BACKGROUND OF THE INVENTION

### Field of the Invention

The present invention relates to a method and a system for recycling reimbursement. More particularly, the invention relates to such a method and such a system for registering, at a recycling station, of the recycling of individual packages and similar items using the camera of a mobile computer device, and to the reimbursement to a user of a corresponding recycling fee.

### Description of the Related Art

In many countries, packaging material is individually recycled in various fractions. For instance, cardboard, plastic, metal and glass packages, such as for foodstuff or other goods are recycled as individual items at predetermined recycling stations. Such recycling stations are typically located in developed areas for convenient recycling by users of such packaging. The corresponding is true also for other types of recyclable physical articles, further including consumer electronics, articles of clothing and food residues. Herein, all such recyclable physical articles will in the following be denoted “recyclable articles”.

It is generally desired to increase the proportion of recyclable articles which is recycled. For some types of recyclable articles, such as glass and aluminium containers, specific deposit fee arrangements are used, where each individual article is marked with a barcode or similar, entitling a recycling user a reimbursement of a deposit fee paid in connection to the initial purchase of the product in question. For many other types of recyclable articles, however, there is no such deposit system in place, leading to lower recycling proportions.

Hence, there is a need for a simple and easy-to-use system for implementing deposit fee systems for a broader range of recyclable articles, such as packaging material. US 2017/0124643 A1 describes a system for implementing such deposit fee mechanisms for individual packaging. A barcode or similar is printed on each piece of packaging, and the user scans the barcode. In order to verify that the user is actually at the recycling station, a cross-checking is made between the current location of the user's mobile device to the predetermined location of the recycling station.

CN 103985194 A discloses another system implementing deposit fee mechanisms for packaging that have previously been purchased using the same system. Also in this solution, a cross-checking is made regarding the recycling station location.

These systems are, however, not very user-friendly. In order to do the said cross-checking, the mobile phone must read its location data in connection to a scan, typically after a scan is performed. Many times, the location reading takes a certain time to perform. For instance, right after activating the positioning function of a conventional smartphone, a certain reading time is required before an accurate position can be read. After a read, the smartphone may again put the location function in a rest state, making it time consuming and cumbersome to deposit many recyclable articles at a time, since the location of the smartphone is read after each scan of an article.

There is hence a need for a more user-friendly solution.

Furthermore, in the solution described in US 2017/0124643 A1, the user may photograph a number of articles, for instance at the grocery store, and then scan the photograph at the recycling station, hence being able to claim reimbursement for articles not actually bought.

There is hence a need for a more secure solution.

Also, the said known solution requires the user's smartphone to be connected to the internet in order to be able to perform the position verification.

US 2011/0225098 A1 discloses another system for remunerating users disposing recyclable articles, in which articles are scanned using a mobile device and wherein the geolocation of a recycling vehicle is used.

### SUMMARY OF THE INVENTION

The present invention solves the above described and other problems.

Hence, the invention relates to a method for registering a reimbursement to a user depositing a plurality of recyclable articles for recycling, which method comprises the steps of a) providing a respective visually readable marking on each of the recyclable articles, which marking visually represents a respective code; b) in a first location, using a mobile computer device to visually depict, using a camera of said mobile computer device, the respective marking of each of said plurality of recyclable articles, and automatically interpreting the respective code based upon the visual depiction in question; which method is characterised in that the method further comprises the steps c) in a second location, reading, using an integrated physical sensor of the mobile computer device, a signal representing a current physical location of the mobile computer device; d) comparing the read signal to a corresponding predetermined physical location or area, and verifying that the read signal corresponds to the predetermined physical location or area; e) in said second location, using the mobile computer device to visually depict, using the camera of the mobile computer device, the respective marking of each of a particular verification subset of said plurality of recyclable articles, and automatically interpreting the respective code based upon the visual depiction in question; f) verifying that the interpreted codes each corresponds to a respective recyclable article in said plurality of recyclable articles and/or that all of the articles belonging to said verification subset have been interpreted; and g) in case the verifications performed in step f) is positive, automatically registering the reimbursement based upon the codes in question.

### BRIEF DESCRIPTION OF THE DRAWINGS

In the following, the invention will be described in detail, with reference to exemplifying embodiments of the invention and to the enclosed drawings, wherein:

FIG. 1 is an overview illustration of various entities partaking in a method according to a first aspect of the present invention;

FIG. 2 is a flowchart illustrating a method according to said first aspect;

FIG. 3 illustrates a visual marking security feature;

FIG. 4 is an overview illustration of various entities partaking in a method according to a second aspect of the present invention; and

FIG. 5 is a flowchart illustrating a method according to said second aspect.

### DESCRIPTION OF THE PREFERRED EMBODIMENTS

All Figures share the same reference numerals for corresponding or same parts.

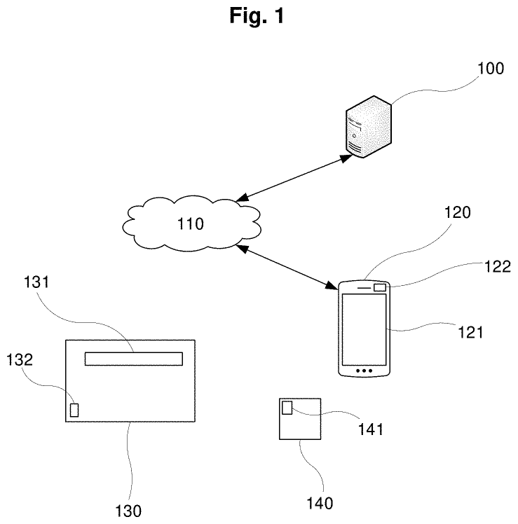

Hence, FIG. 1 illustrates a central server 100, which may be a single, stand-alone server, a cooperating and interlinked set of servers, such as a distributed server functionality, or a combination thereof. What is important is that the functionality provided by the central server 100 is logically accessible via a well-defined API (Application Programming Interface), accessible via the internet 110.

Hence, the central server 100 is connected to the internet 110. To the internet 110 is also connected a mobile computer device 120, such as a mobile telephone with a general-purpose programmable CPU and a general-purpose operating system, such as a conventional so-called “smartphone”. Hence, the mobile computer device 120 and the central server 100 communicate over the internet 110, via said API.

The mobile computer device 120 comprises a camera component 122, the functionality of which can be exploited by a device 120 software function executable on or from the mobile computer device 120 so as to depict items by capturing a digital image of such items. That the device 120 software function is executable “on” the mobile computer device 120 means that the device 120 software function is downloadable onto a memory of the mobile computer device 120 and can be installed and executed locally on said operating system. That the device 120 software function is executable “from” the mobile computer device 120 means that the device 120 software function is accessible from the mobile computer device 120, such as upon the command of a user of the mobile computer device 120, via a remote web service; as a part of the functionality of a web page accessible by the mobile computer device 120; or similar. The device 120 software function may be accessible by a user of the mobile computing device 120 via a screen 121 of the mobile computer device 120. The device 120 software function is in automatic, digital communication with the central server 100 for performing the functionality described herein.

The device 120 software function may be issued by the operator of the central server 100, or the device 120 software function as well as a corresponding central server 100 software function may be issued by the same issuing third party. In general, the device 120 software function the central server 100 software function are arranged to cooperate, to a minimum via said API provided by the central server 100 and used by the device 120 software function, possibly by certain parts of the combined software functionality being allocated on the central server 100 while certain other parts of the combined software functionality is allocated to the device 120. This will be exemplified below. In general, the term “software function” refers to the combination of such a cooperating device 120 software function and server 100 software function. This combined software functionality is arranged to perform all the automatic steps described herein, unless stated otherwise.

A recycling or deposit station 130 is arranged to receive recyclable articles 140, such as glass, paper, cardboard, plastic or metal articles, such as empty packaging material; used consumer electronics; used articles of clothing; food residues; or any other article which is recyclable at the recycling station 130. The recycling station 130 may comprise a receptacle 131 for the said article, preferably at least one such receptacle 131 being arranged to accept only a specific type of recyclable article. For instance, the recycling station 130 may be a community recycling station with different receptacles 131 for coloured and non-coloured glass, metal, plastics, paper and cardboard, respectively.

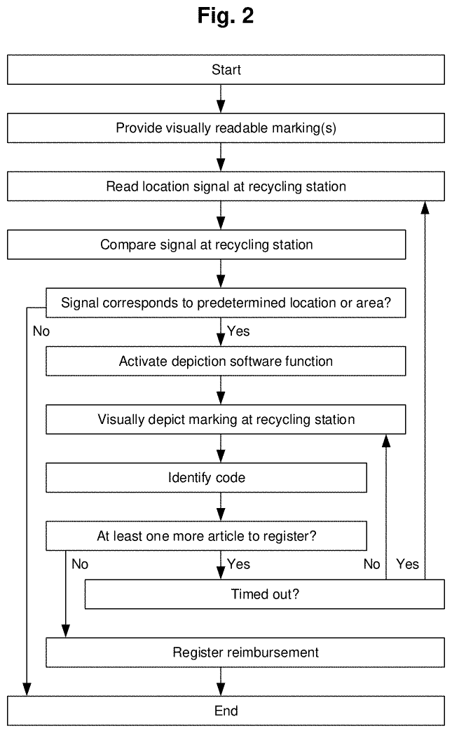

FIG. 2 illustrates a method according to a first aspect of the present invention, for registering a reimbursement to a user depositing a recyclable article 140 for recycling. Herein, “registering” a reimbursement may mean that a sum of money or other remuneration accruing as a result of the deposit of the recyclable article 140 at the recycling station 130 is registered, by the central server 100, at an account associated with the user; that a corresponding sum of money or other remuneration is actually automatically paid out to the user; or any other such automatically performed action resulting in the user being duly remunerated for the deposit of the recycled item 140 in question.

In a first step, the method starts.

In a subsequent visually readable marking provision step, a visually readable marking 141 is provided on the recyclable article 140, which marking 141 visually represents a digital code. The marking 141 may be any suitable type of visually readable marking 140, such as a barcode, a QR code, a holographic code, and so on. That the marking 141 is “visually readable” means that the marking is readable using the built-in camera 122 of the mobile computer device 120. The marking 140 may or may not be a printed code on the article 140. The marking 140 may, in some embodiments, not comprise a radio sender or transmitter, such as an RFID code. By using a marking 140 which is optically readable but not readable using a wireless radio communication device, the provision of such readable codes 141 on many articles 140 will be less expensive.

It is realized that the article 140 may be of different constitutions. In case the article 140 is a piece of packaging or similar, the visually readable marking 141 may be provided as a printed label or similar, directly on the article 140 in question. In case the article 140 is not printable, such as is the case with food residues, used pieces of clothing, etc., the visually readable marking 141 may be provided in other suitable ways, such as using purpose-made transport packaging or using an attached label.

The code may be associated with various information in the central server 100, such as type of article 140 or the individual article 140 identity. The code may be a unique code, in particular it may be unique for each individual article 140. Irrespectively of whether or not the article 140 is unique, the code may be associated, in the central server 100, with sufficient information for the central server 100 to be able to determine relevant characteristics, such as type (cash, bonus points, etc.) and amount (cash amount, number of points, etc.), of reimbursement to provide to the user of the depicting mobile device 120.

It is realized that this visually readable marking provision step may be performed ahead of time, such as during the manufacturing of each individual article 140.

In a subsequent at-station location reading step, a user will have arrived at the recycling station 130, bringing at least one, preferably a plurality, of articles 140 for deposit at the recycling station 130.

Hence, once the user is at the recycling station 130, a signal is read using an integrated physical sensor of the mobile computer device 120, which the user brings with her to the recycling station 130. The read signal represents a current physical location of the mobile computer device 120. For instance, the signal may be a geolocation signal, such as a GPS signal, in which case the above-described software function may interpret the read signal into a present geolocation of the mobile computer device 120. In other examples, the signal may be a different signal than a geolocation signal, as will be exemplified below. In the latter case, additional information may be required to interpret the received signal and translate the information carried by the received signal into a current physical location of the mobile computer device 120. Such translation may be performed by the said device 120 software function and/or by the server 100 software function.

In a subsequent at-station signal comparing step, the read signal is compared to a corresponding predetermined physical location or area. The predetermined physical location or area may be a location or area of the individual recycling station 130, and may be digitally described beforehand in a memory of the mobile computer device 120 and/or of the central server 100, or be communicated from the central server 100 to the device 120 software function in connection to the at-station signal comparing step. The comparison may also be performed by the central server 100 upon receiving the read signal or the translated physical location of the mobile computer device 120 from the device 120 software function. The server 100 software function may comprise or have access to a database comprising associations between individual recycling stations 130 and respective predetermined physical location or area information.

The comparison may take place in different ways, but the over-arching aim is to verify that the user carrying the mobile computer device 120 is actually currently at the recycling station 130. For instance, a geographic area may be defined around the physical recycling station 130, and the comparison step may comprise comparing a GPS position read by the mobile computer device 120 to the defined geographic area, whereby the comparison is affirmative if the GPS position is within the defined geographic area. A second example is that the mobile computer device 120 uses a local wireless reading capability, such as Bluetooth®, NFC or RFID, to read or connect to a corresponding wireless beacon locally arranged at the recycling station 130. A third example is that the mobile computer device 120 uses a wireless internet provision functionality, such as a WiFi functionality, to connect to a corresponding wireless internet network, such as a WiFi network, locally arranged at the recycling station 130. A fourth example is that the mobile computer device 120 uses the camera 122 to depict a visual marking locally arranged at the recycling station 130. In the second, third and fourth examples, the comparison is affirmative if the reading, connection or depiction, respectively, is verified to be in relation to said locally arranged beacon, network or visual marking, respectively. This verification may be performed by device 120 software function and/or the server 100 software function (in the latter case after communication of corresponding information from the device 120 to the central server 100).

The comparison according to the present invention may be performed also in other ways, the important thing being that the mobile computer device 120 reads a wireless signal representing the current locality or location of the mobile computer device 120, and that the comparison aims at determining whether or not the mobile computer device 120 is indeed currently physically at the recycling station 130 or not.

Hence, the read signal in the at-station location reading step may be a wireless signal read from a locally arranged wireless transmitter 132, which in turn may be fixedly installed at a recycling station 130. The wireless transmitter 130 may be arranged to provide wireless internet access to the mobile computer device 120 and/or to other devices disposed in the local neighbourhood of the recycling station 130. Alternatively or additionally, the read signal may be a geolocation signal, such as a GPS signal.

The comparison step may preferably be associated with a timer, so that only a maximum time period is allowed to pass between the reading of the said wireless signal and the actual comparison. Thereafter, an affirmative comparison may also be associated with another timer, so that an affirmative comparison is only valid during a particular time period before depiction of the visual marking 141 on the article 140 must be performed and reimbursement consequently is allowed (see below).

In case the comparison step was not affirmative, the device 120 software function may be arranged to provide the user, on the screen 121, with information to this end, and possibly also directions to the nearest recycling station 130 and/or instructions regarding how to perform a wireless signal reading using the mobile computer device 120. For instance, the device 120 software function may provide the user with the option to switch on the GPS function of the device 120.

In a subsequent at-station visual depiction step, the mobile computer device 120, and in particular the camera 122 of the mobile computer device 120, is used to visually depict the said marking 141 on the recyclable article 140. Then, in the same at-station visual depiction step, the corresponding code is automatically interpreted, based upon the visual depiction in question, and identified. For instance, the device 120 software function may perform this interpretation, or the device 120 software function may communicate the digital image depiction of the recyclable article 140 to the central server 100 for interpretation by the server 100 software function.

The interpreted code may be verified for validity in various ways. If found to be valid, the article 140 is considered deposited at the recycling station 130. In certain embodiments of the invention, the recycling station 130 as such does not comprise additional article 140 registering functionality, such as an RFID or barcode scanner, arranged to register an article 140 being deposited in the receptacle. Instead, the depiction of the visually readable marking, and the interpretation and verification of the corresponding code, is sufficient for determining that the article 140 has been duly deposited. This avoids the expensive and complicated provision of registering hardware in the normally rough environment of a recycling station 130.

In a subsequent reimbursement registration step, the said reimbursement is registered, as described above, based upon the identified and verified code in question.

For instance, the user of the mobile computer device 120 may have been identified when signing up for or registering an account with the central server 100, and/or installing or using the device 120 software function, so that the central server 100 has knowledge of the identity of the user, for the purpose of directing the reimbursement to the correct user. Hence, the device 120 software function may be tied to the user, via a login; a hardware-specific identifier of the device 120, such as a MAC address of the device 120; or in any other suitable way.

Furthermore, the type and/or amount of reimbursement to be effected may depend on the article 140 or type of article 140. This information may be available to the central server 100 via the read code, for instance by the server 100 software function comprising or having access to a database comprising codes associated with particular reimbursement policies.

According to the first aspect of the present invention, the at-station signal comparing step is performed before the at-station visual depiction step. Moreover, the method according to the second aspect of the invention further comprises an additional step, namely a visual depiction software function activation step, in which a visual depiction software function which is used in the at-station visual depiction step is activated for performing the depiction in question.

The activation may be performed by the device 120 software function, upon an affirmative location comparison which is performed by the device 120 software function or as a result of the receipt by the device 120 software function from the central server 100 of information that the location comparison, performed by the server 100 software function, was affirmative. The visual depiction software function is preferably executed on or from the device 120 software function, and may be a part of the device 120 software function, and the activation function may be performed by the device 120 software function. The visual depiction software function is preferably not accessible other than via the software function, at least not for depicting and interpreting the visual marking 141.

The activation in this step may hence be the only way for the user of the mobile computer device 120 to activate the visual depiction software function. In particular, the activation in said activation step is not merely a convenient way of bringing up or activating a depiction function, such as a barcode scanning function, on the mobile computer device 120, which depiction function can also be manually activated by the user. To the contrary, in order to use the depiction function of the device 120 software function, it is necessary to first perform the at-station signal comparison step and to verify that the read signal corresponds to the said predetermined physical location or area. It may even be so that the visual depiction software function is automatically inactivated as a result of any of the timers described herein timing out, so that a verified device 120 location is no longer valid.

In general, according to this first aspect of the invention, the activation of the depiction function is only performed if the (sufficiently recently) read signal corresponds to the predetermined physical location or area in the signal comparison step.

Since the depiction function is only activated after the location of the mobile computer device 120 has been verified to be in the predetermined location, that is at the recycling station 130, it is only possible for the user to deposit the recyclable article 140 as described above, and to get duly reimbursed for recycling the article 140, when actually at the recycling station 130 and also, in connection thereto, registering the article 140 in question using the visual depiction software function.

The visual depiction software function may be conventional as such regarding the depiction itself, for instance it may comprise software functionality for activating the camera 122 of the device 120 and to provide on-screen 121 instructions to the user for depicting the marking 141. For instance, the screen 121 may be used as a viewfinder to guide the user through the depiction process. A digital image may be captured and automatically processed using digital image processing, as is conventional as such, for instance so as to find and interpret any QR codes existing in the depicted image. As mentioned above, the digital signal processing may be performed by the device 120 software function and/or the server 100 software function.

It may be so that the depiction function, after being activated, is automatically deactivated after a certain time period, and/or after a visual marking 141 of one article 140 has been depicted and the corresponding code has been identified. Then, the mobile computer device 120 must again read the wireless signal, and the comparison must be made anew in order for another visual marking 141 on another article 140 to be depicted.

However, in one embodiment of the present invention, illustrated in FIG. 2, several different articles 140 are deposited during one and the same recycling activity, each of which articles 140 have previously been provided with a respective visually readable marking 141 as described above, visually representing a respective code. Then, one and the same affirmative comparison between a read particular signal to a predetermined physical location or area can be used to activate the depiction function for use when depicting respective visual markings 141 for more than one articles 140, without the signal having to be read again.

In particular, within a predetermined depiction time period after the performing of the at-station location reading and signal comparing steps in relation to a particular first recyclable article 140, in which the comparison in the signal comparing step found that the read signal indeed corresponded to the predetermined physical location or area in question, the activation of the visual depiction software function is again performed, or the visual depiction software is kept in an activated state without being placed in an inactive state, without first again performing the at-station location reading and signal comparing steps, for a second recyclable article 140 for which the visual depiction step is performed within said predetermined depiction time period. As illustrated in FIG. 2, after the code of a first article 140 has been identified, and if there is at least one more article 140 to depict and deposit for reimbursement, it is determined whether or not the at-station comparing step has timed out, in other words if the mentioned depiction time period has expired. If the depiction time period has run out, a new wireless signal is read and compared. If not, the method may reiterate back directly to the visual depiction step.

In particular, this may be performed iteratively, whereby a second recyclable article 140 becomes a new first article 140 in the next iteration of the method, so that each of a series of articles 140 are handled in the same way, for instance by the depiction time period being restarted for each depicted new article 140, such as in connection to the depiction or the identification of the identified code. This way, the user, once the depiction functionality has been activated, can continue to register a set of articles 140, one at a time, without the mobile computer device 120 having to re-read the wireless signal in question, as long as the next article 140 is deposited within the used depiction time period after the immediately preceding article 140.

The predetermined depiction time period may be between 2 and 60 seconds, such as between 2 and 10 seconds.

This iterative process may go on for as many articles 140 as the user wishes to register at the time, indefinitely. However, in one embodiment the method can be performed for at the most a predetermined number, such as at the most 10, recyclable articles 140, before the depiction function is again deactivated and the at-station location reading and signal comparing steps must again be performed to reactivate the depiction software. Alternatively on additionally, a total time limit may be used, as counted from the at-station location reading step, after which total time limit a new location reading and signal comparing must be performed in order to be able to continue depicting markings 141 on further articles 140. Such a total time period may be between 1 and 10 minutes.

Once these at-station reading and comparing steps have been performed again, another iterative burst of a certain maximum number of article 140 registrations can be performed before the activation procedure must again be performed. This way, it is avoided that a user leaves the recycling station 130 while continuing to register articles 140 continuously.

An alternative or supplemental way to solve this problem is to require that the at-station location reading and signal comparing steps are performed once more, right after the deposition of all articles 140 is finalized but before the reimbursement of the registered articles 140 can be effected, so that it is verified that the mobile computer device 120 is actually physically present at the recycling station 130 both in immediate connection to the deposit of a first article 140 and of a last article 140.

Irrespectively of the number of individual articles 140 that are registered by the user, it is preferred that the reimbursement registration step is performed only once, after the registering deposition of all recyclable articles 140, in a particular of a collection of such articles 140 that the user has brought to the recycling station 130 for deposit, and that the reimbursement registration step is then performed in relation all said articles 140.

According to one embodiment of the invention, the comparison in the above-discussed at-station signal comparing step is performed locally by the mobile computer device 120, and in particular by the device 120 software function, based upon a previously registered set of predetermined physical locations or areas, which set may be locally stored in the mobile device 120. This way, the at-station signal comparing step may be performed completely autonomically and automatically by the mobile computer device 120, without requiring a live internet or other data connection.

In some embodiments, the method may further comprise a code comparison step, in which the code interpreted in the at-station visual depiction step is compared to codes corresponding to previously depicted visual markings 141. Then, the reimbursement registration step is only performed if the code in question is encountered for the first time. This way, a user is not allowed to deposit the same article 140 several times, and it is not possible to for instance photograph markings 141 of articles 140 not bought and use such photographs instead of actual markings 141 at the recycling station 130. In this case, the codes are preferably unique for each individual article.

Such a code comparison step may only be performed in relation to codes interpreted from visual markings 141 previously depicted, and for which codes, in the respective at-station signal comparing step in question, the read signal in question was found to correspond to the predetermined physical location or area in question. In other words, only codes that have been previously read in relation to deposits of articles 141 are considered “used”, and consequently cannot be validly used for deposition of further articles 140 thereafter.

Hence, the central server 100 may keep a register over still active and already deposited codes, corresponding to markings 141 on articles 140 not yet having been deposited and already deposited articles 140, respectively. The information in this register may be made available to the device 120 and/or server 100 software function, as applicable.

Again, similarly to the at-station signal reading step, the said code comparison step may be performed locally, on the mobile computer device 120 and using the device 120 software function, without the device 120 requiring an internet or other external data connection. In this case, a register of active codes could be downloaded to the device 120 before depiction starts.

In some embodiments, one and the same piece of software, namely the device 120 software function, may be used both for said at-station visual depiction step and for said at-station signal comparing step, and possibly also said at-station location reading step. This provides for a well-controlled and secure solution.

Furthermore, the same piece of software may also provide a guide function, such as via a graphical user interface on the screen 121, allowing the user to find information regarding the physical location of a recycling station 130, such as the nearest recycling station 130. In particular, such a guide function may be provided with updated physical location data, as well as said predetermined location or area, from the central server 100.

In some embodiments, the method may furthermore comprise a physical trail measuring step, in which the mobile computer device 120 measures a physical geolocation trail of the mobile computer device 120. Then, the signal comparing of the at-station signal comparing step may further be based upon this physical trail measured by the mobile computer device 120 during a certain time period, such as up to 12 hours, leading up to the at-station location reading step, and the trail may be compared to the said predetermined location or area. For instance, statistical methods may be applied to verify that the physical trail supports the user being currently physically present at the recycling station 130. By way of example, this may include investigations that it is physically possible or likely for a user carrying the mobile computer device 120 to have traveled to the recycling station based upon the measured trail; tests for geolocation signal spoofing attempts; and so on. This will provide protection from GPS tampering attempts from malicious users.

In particular, the said physical trail measuring step may use information regarding to what mobile antenna or antennae the mobile computer device 120 is currently and/or has recently been connected. The physical trail measuring step may use only such antenna connection information, or use antenna connection information in combination with GPS data, Wifi connection history data, and/or any other available and interpretable geolocation data read by or for the mobile computer device 120.

In some embodiments, the visual marking 141 comprises at least one security function making it non-practical or impossible to photograph the visual marking in a location away from the recycling station 130 and to later use the photograph for the at-station visual depiction step instead of the actual marking 141 on the actual respective article 140.

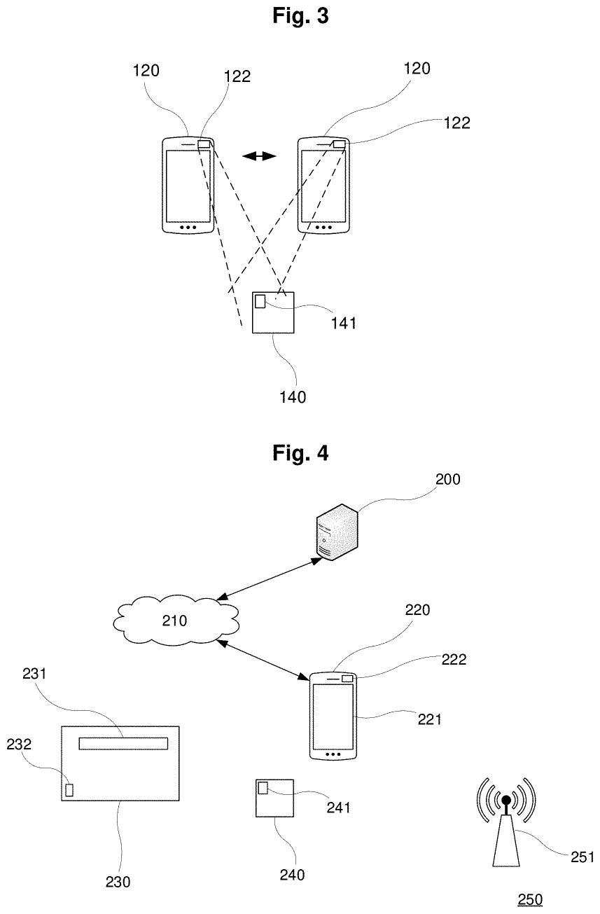

One example of such a security function is illustrated in FIG. 3, in which the mobile computer device 120 is illustrated with its camera 122 oriented in two different angles in relation to the visual marking 141 on a particular article 140. In this case, the visual marking 141 is arranged to look visually different when observed from these two different angles, and to represent a first code when viewed from the first angle and a second, different, code when viewed from the second, different, angle. More generally, the code information to be interpreted is at least different between two different observation angles. This may be achieved in several conventional ways, such as using lenticular printing; holographic techniques; and so forth.

Then, the at-station visual depiction step may comprise depicting the visual marking 141 both from the said first and second angles, and possible even from three or more different angles, depending on the type of visual marking 141 used. Moreover in this case, each of said respective codes, that may contain different information, read from each of said angles, are interpreted and identified for verification as described above. For instance, two different codes, visible for interpretation when the marking 141 is viewed from two different angles, may together carry enough information for the code identification to be possible. Hence, the user must depict the visual marking 141, using the mobile computer device 120, from each of the required at least two angles for the deposit of the article 140 to be considered effected by the system.

In particular, the visual depiction software function may be arranged to activate a film capture function of the camera 122, and to use this film capturing function for the depiction of the visual marking 141. Hence, the depiction of the visual marking from the first and second angles may then take place in one and the same sweep using the said camera 122 of the device 120. Moreover, the different interpreted codes (corresponding to different marking 141 viewing angles) may not be considered validly interpreted unless they are interpreted using different sections of one and the same captured film clip. Further, digital image analysis methods may be applied to make sure the user actually does a “sweep” with the camera 122 across the said angles, rather than switch between two photographs previously taken from two different angles of the marking 141 in question. For instance, such image analysis may check for a continuous motion in relation to a particular foreground object, as opposed to a more complete change of scene foreground.

An alternative or additional way of preventing the user to use a previously taken photograph of a marking 141 is that the at-station visual depiction step comprises depicting, in one and the same image, both the visual marking 141 in question and a physical environment to the visual marking 141, such as a background showing the ground; part of the recycling station 130; the sky; or any other suitable representation of said environment. It may also be checked that the actual article 140 is also at least party depicted in the same image. Then, the method may comprise a physical environment depiction analysis step, in which the physical environment depiction is compared to an expected state using a particular expected parameter, selected among current outdoors weather conditions and current daylight levels. Finally, the reimbursement registration step may only be performed if the said comparison turned out in the positive.

Yet another, alternative or additional, way of preventing users to use marking 141 photographs is that the method comprises a code activation step, performed before the at-station location reading step. In such a code activation step, the code in question is activated in the central server 100. Then, the reimbursement registration step is only performed after a verification has taken place that the code in question has indeed been activated. This may be performed for each of the codes corresponding to visual markings 141 on the articles 140 in the above described collection of articles 140 to be deposited. In connection to the deposit of an article 140, the code of that article 140 is then deactivated in the central sever 100 as described above, so that the same article 140 cannot be deposited again.

Preferably, the said code activation step is automatically performed in connection to the registering of a purchase of the recyclable article 140 on which the visual depiction representing the code in question is arranged. For instance, a cashier at a supermarket may be arranged to automatically send, to the central server 100, information that the article 140 carrying the particular code in question has been checked out by a customer, whereupon the server 100 software function automatically activates the code.

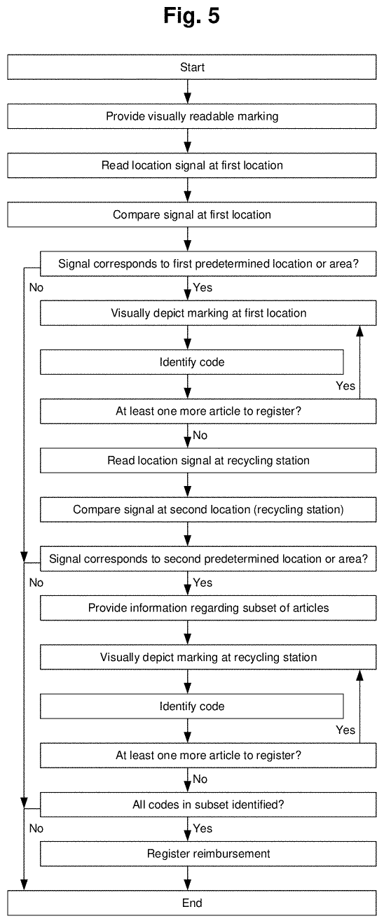

FIG. 4 is similar to FIG. 1, and illustrates a system for performing a method according to a second aspect of the present invention, while FIG. 5, being similar FIG. 2, illustrates the method steps of a method according to said second aspect. FIG. 4 shares the same last two digits or each reference numeral with FIGS. 1 and 2 for corresponding parts.

The second aspect relates to a method for registering a reimbursement to a user depositing a plurality of recyclable articles 240 for recycling. Each article 240 comprises a visual marking 241 as described above, in connection to the first aspect of the present invention. Further as described above, a central server 200 is connected, via an API and the internet 210, to a mobile computer device 220 comprising a screen 221 and a camera 222. A recycling station 230 is arranged with a receptacle 231 and an optional wireless transmitter 232. All these things may be as described above, including the server 200 software function and the device 220 software functions, etc.

In FIG. 4, a particular first location 250 is also illustrated. The first location 250 is physically separated from the recycling station 230, in the sense that a location reading step and a signal comparing step like the ones described above but performed at the first location 250 will not result in the software function verifying that the mobile device 220 is physically present at the recycling station 230. For instance, the first location may be at the home or workplace of the worker; or anywhere outside of the corresponding predetermined physical location or area of the recycling station 230.

In this second aspect, the recycling station 230 will sometimes be denoted a “second location”, in order to differentiate it from said “first location”.

As mentioned, FIG. 5 illustrates the method steps of a method according to the second aspect of the invention.

In a first step, the method starts.

In a subsequent step, similar to the visually readable marking provision step described above, a respective visually readable marking 241 is provided on each of the recyclable articles 240, which marking 241 visually represents a respective code, as described above.

Thereafter, an at-first-location visual depiction step is performed, which step corresponds to the above-described at-station visual depiction step, but which is performed at said first location 250. Hence, at the first location 250, the mobile computer device 220 is used by the user to visually depict, using the camera 222 of said mobile computer device 220, the respective marking 241 of each of said plurality of recyclable articles 240. Then, for each of said articles 240, the respective code is automatically interpreted based upon the visual depiction in question. As described above, this and other steps of the second aspect is performed by the device 220 and/or server 200 software function.

After this at-first-location visual depiction step, all articles 240 of said plurality of articles have been identified and registered, using their respective visual markings 241. It is noted that it is not strictly necessary, although advantageous, that each code is unique for each article 240 in this second aspect. This makes each article 240 individually identifiable. However, the codes may also be unique for each type or class of article 240. For instance, all cereal packages of a particular brand and size may share the same code. In that case, the software function needs only keep track of the total number of each unique code identified.

The software function, such as the central server 100, may in said at-first-location visual depiction step add all identified codes to a set of identified codes associated with the plurality of articles 240 in question, so that the software function has information regarding all codes used for articles 240 comprised in said set of articles 240 to be deposited.

Once the user has registered all the articles 240 she wants to deposit for recycling, she sets off to the recycling station 230, bringing all the articles 240 with her.

At the recycling station (the second location), the above-described at-station location reading and at-station signal comparing steps are performed, using the mobile computer device 220, and it is verified that the read signal corresponds to the predetermined physical location or area of the recycling station 230. As a result, it is verified that the user (holding the device 220) is currently actually at the recycling station 230. This may result, as described above, in the automatic activation of the image depiction software function.

Then, and preferably not before the location verification at the recycling station 230, the central server 200 may provide to the user, such as via said on-screen 221 graphical user interface, information regarding what articles to register at the recycling station 230.

Namely, the central server 100 may provide a particular verification subset of the said plurality of articles 240 to be deposited, which verification subset does not contain all articles 240 of said plurality, and which may be randomly selected by the central server 100. The verification subset may not be known to the user beforehand. Suitable sizes for the said-verification subset may either be a particular number of articles 240, such as between 3 and 10 articles, irrespectively of the number of articles 240 in said plurality to be deposited; or a particular fraction, such as between 5%-25% of the said plurality.

The user may be provided with information regarding the contents of said verification subset by the corresponding articles 240 being identified in a form understandable to the user, such as using images of the actual articles 240 fetched from a database containing images of possible article types; and/or descriptive names or texts fetched from a similar database. Each image and/or text can be fetched using the identified code in question as key.

In a way corresponding to the above described visual depiction software function activation step, the verification subset information may not be provided to the user before it has been verified that the read signal in the at-station location reading step actually corresponds to the predetermined location or area. In this second aspect of the invention, the predetermined location or area of the recycling station 230 is sometimes denoted the “second” predetermined location or area.

In a subsequent at-station visual depiction step, which may be similar to the at-station visual depiction step described in the context of the first aspect, and which is performed at the recycling station 230 and using the mobile computer device 220, the respective marking 241 of each of the articles 240 belonging to said verification subset is visually depicted, using the camera 222 of the mobile computer device 220. The respective code is automatically interpreted, by the software function as described above, based upon the visual depiction in question.

It is hence noted that, in this second aspect of the invention, all articles 240 must not be registered once the user is at the recycling station 230. It is sufficient to register the verification subset of articles 240.

Once all articles 240 in said verification subset have been depicted and registered, in a subsequent subset verification step, it is verified that the interpreted codes each corresponds to a respective recyclable article 240 in said plurality of recyclable articles 240. It may alternatively, or additionally, be verified that all of the articles 240 in said verification subset have been interpreted, and hence that they have been depicted and registered.

In case the verifications performed in the said subset verification step, and possibly also if the at-station signal comparing step verification regarding the second predetermined location or area turns out to be positive, the reimbursement is automatically registered, as described above, based upon the codes in question.

Using a method according to this second aspect, a user may register each article 240 in said plurality of articles 240 in a first location, such as a place which the user prefers, such as in the user's home. Once at the recycling station 230, only a subset of the articles 240 must be re-registered in order for the user to be able to deposit all the articles 240 of said plurality. This provides convenience to the user in many situations, such as when weather conditions are sub-optimal at the recycling station. Still, sufficient security is provided so as to disencourage users to try to take undue advantage of the system.

As illustrated in FIG. 5, the method may also comprise a sequence of steps, performed before or in connection to the registering of the plurality of articles 240 at the first location, where it is verified that the mobile computer device 220 is actually currently located at the first location. The visual depiction software function may not be activated at the first location if this is not found to be the case, or the articles 240 are not deemed by the software function to have been duly registered until this has been found to be the case. This first location verification may be performed in a way similar to the above-described at-station location reading and at-station signal comparing steps, only performed at the first location and in relation to a signal read at the first location and compared to a first predetermined location or area associated with the first location.

For instance, an internet local area network at the user's house may comprise a wireless access point 251. When the mobile computer device 220 is connected to the access point 251, the device 220 is deemed to be at the first location. Alternatively, GPS data sensed by the mobile device 220 may be compared to a first predetermined geolocation area corresponding to the first location in a way corresponding to the one described above.

The comparison between the registered articles 240 and the verification subset at the recycling station 230 may be performed completely by the device 220 software function in the mobile computer device 220, resulting in that the user does not require an active internet connection to the device 220 when at the recycling station 230. The information necessary to perform said comparison, such as the contents of the verification subset, may be provided to the mobile computer device 220 before the user arrives at the recycling station 230, such as in connection to finalizing the registering of the plurality of articles 240 to deposit.

Many of the method steps in the second aspect may furthermore be similar to the ones described above in relation to the first aspect. For instance, the visual depiction software function may not be activatable on the device 220 unless the current location of the device 220 is verified to be at the recycling station 230.

Above, preferred embodiments have been described. However, it is apparent to the skilled person that many modifications can be made to the disclosed embodiments without departing from the basic idea of the invention.

For instance, many types of articles, apart from the ones described above, may be deposited using the present methods, and other types of recycling stations may be used.

The recycling station 130, 230 may be subdivided into several subpart recycling stations, each having one or more receptacles 131, 231. For instance, a recycling station 130, 230 may have a subpart station which is for deposition of metal articles, while a different subpart station is for deposition of plastic articles. Then, the code of each article 140, 240 may be associated with recycling information in the software function, so that deposition by visual depiction of a particular article 140, 240 is only allowed if the device 120, 220 is located within a particular predetermined area or location associated with the correct particular subpart station. This verification may take place in the corresponding way as the verification of whether or not the device 110, 220 is located at the recycle station 130, 230, as described above.

The above described first and second aspects can be combined in various ways to provide even more benefits for users.

For example, a temporary recycling station 130, 230 can be defined at a temporary event, such as at a fair, a festival, a concert or similar. The definition may be a particular geolocation area; the coverage area of a Bluetooth® beacon; or similar, as described above. Then, visiting users can bring articles 140, 240, such as empty packaging material, to the temporary recycling station 130, 230, and there deposit such articles 140, 240 and automatically receive due remuneration. For instance, the device 120, 220 software function may be associated with a particular digital and personalized pass or ticket, so that the system has knowledge of the user's identity when the user enters the temporary event area. Using the first aspect of the invention, recyclable articles may be collected and registered anywhere within the event area, while the actual deposit requires that the articles are brought to the defined temporary recycling station 130, 230. Using the second aspect, the users may then deposit gathered articles without having to spend time re-registering all collected articles.

In a similar example, a city, a community or similar may set up a program in which users are remunerated for collecting recyclable articles, such as empty packaging. Articles 140, 240 may be collected anywhere in the city or community, and brought to the recycling station for easy and quick disposal and automatic remuneration collection.

Furthermore, the sequence registering of several articles 140 within a certain depiction time period may be used with the depiction at the recycling station 230 in the second aspect.

In general, all which has been said regarding the first aspect can be used with the second aspect and vice versa, as applicable.

Hence, the invention is not limited to the described embodiments, but can be varied within the scope of the enclosed claims.

1. Method for registering a reimbursement to a user depositing a plurality of recyclable articles (140;240) for recycling, which method comprises the steps of
a) providing a respective visually readable marking (141;241) on each of the recyclable articles (140;240), which marking (141;241) visually represents a respective code;
b) in a first location (250), using a mobile computer device (120;220) to visually depict, using a camera (122;222) of said mobile computer device (120;220), the respective marking (141;241) of each of said plurality of recyclable articles (140;240), and automatically interpreting the respective code based upon the visual depiction in question;
wherein the method further comprises the steps
c) in a second location (130;230), reading, using an integrated physical sensor of the mobile computer device (120;220), a signal representing a current physical location of the mobile computer device (120;220);
d) comparing the read signal to a corresponding predetermined physical location or area, and verifying that the read signal corresponds to the predetermined physical location or area;
e) in said second location (130;230), using the mobile computer device (120;220) to visually depict, using the camera (122;222) of the mobile computer device (120;220), the respective marking (141;241) of each of a particular verification subset of said plurality of recyclable articles (140;240), and automatically interpreting the respective code based upon the visual depiction in question;
f) verifying that the interpreted codes each corresponds to a respective recyclable article (140;240) in said plurality of recyclable articles (140;240) and/or that all of the articles (140;240) belonging to said verification subset have been interpreted; and
g) in case the verifications performed in step f) is positive, automatically registering the reimbursement based upon the codes in question.

2. The method according to claim 1, wherein step d) is performed before step e), and wherein the method furthermore comprises the additional step of activating a visual depiction software function which is used in step e) for performing the said depiction, which activation is only performed if the read signal corresponds to the predetermined physical location or area in step d).

3. The method according to claim 1, wherein codes are individually associated with either a respective type of article (140;240) or a respective individual article (140;240), and in that a user of the mobile computer device (120;220) is provided with information regarding the articles (140;240) belonging to the verification subset before step e) is performed.

4. The method according to claim 1, wherein the reimbursement in step g) is performed only once, and after the deposition of all recyclable articles (140;240) in the plurality of recyclable articles (140;240), for all said articles (140;240).

5. The method according to claim 1, wherein the comparison in step d) is performed locally by the mobile computer device (120;220), based upon a previously registered set of predetermined physical locations or areas.

6. The method according to claim 1, wherein the read signal is a wireless signal read from a locally arranged wireless transmitter (132;232).

7. The method according to claim 6, wherein the wireless transmitter (132;232) is fixedly installed at a recycling station (130;230).

8. The method according to claim 6, wherein the wireless transmitter (132;232) is arranged to provide wireless internet access.

9. The method according to claim 1, wherein the read signal is a geolocation signal, such as a GPS signal.

10. The method according to claim 1, wherein the method further comprises a code comparison step, in which the code interpreted in step b) is compared to codes corresponding to previously depicted visual markings (141;241), and wherein step g) is only performed if the code in question is encountered for the first time.

11. The method according to claim 10, wherein the code comparison step is performed locally, on the mobile computer device (120;220).

12. The method according to claim 1, wherein one and the same piece of software is used both for said depiction in steps b) and e), as well as said location or area comparison.

13. The method according to claim 12, wherein the same piece of software further provides a guide function allowing a user to find information regarding the physical location of a recycling station (130;230), and wherein the guide function is provided with updated physical location data, as well as said predetermined location or area, from a central server (100;200).

14. The method according to claim 1, wherein the method furthermore comprises a physical trail measuring step, in which the mobile computer device (120;220) measures a physical geolocation trail of the mobile computer device (120;220), and wherein the comparison in step d) is further based upon the physical trail measured by the mobile computer device (120;220) during a time period leading up to step c) is compared to the predetermined location or area.

15. The method according to claim 14, wherein the physical trail measuring step uses information regarding to what mobile antenna or antennae the mobile computer device (120;220) is currently connected.

16. The method according to claim 1, wherein the visual marking (141;241) is arranged to visually represent a first code when viewed from a first angle and a second, different, code when viewed from a second, different, angle, and wherein the visual depiction in step d), and preferably also in step b), comprises depicting the visual marking (141;241) both from the first and second angles, whereby both the first and second codes are interpreted.

17. The method according to claim 16, wherein the depiction of the visual marking (141;241) from the first and second angles takes place in one and the same sweep using the said camera (122;222).

18. The method according to any claim 1, wherein the visual depiction in step e) comprising depicting, in one and the same image, both the visual marking (141;241) and a physical environment to the visual marking (141;241), wherein the method comprises an physical environment depiction analysis step in which the physical environment depiction is compared to an expected parameter, selected among current outdoors weather conditions and current daylight levels, and wherein step g) is only performed if the said comparison turned out in the positive.

19. The method according to claim 1, wherein the method further comprises a code activation step, performed before step b), in which the code is activated in a central server (100;200), and wherein step g) is only performed after a verification has taken place that the code has indeed been activated.

20. The method according to claim 19, wherein the code activation step is automatically performed in connection to the registering of a purchase of the recyclable article (140;240) on which the visual depiction representing the code in question is arranged.

21. The method according to claim 1, wherein the code is a unique code.
